(19) United States
(12) Patent Application Publication
(10) Pub. No.: US 2018/0011878 A1
(43) Pub. Date: Jan. 11, 2018

(54) DATABASE INTEGRATION DEVICE, DATABASE INTEGRATION METHOD, AND COMPUTER PROGRAM PRODUCT

(71) Applicant: Kabushiki Kaisha Toshiba, Minato-ku (JP)

(72) Inventors: Taiga KATAYAMA, Ota (JP); Mototaka KANEMATSU, Yokohama (JP)

(73) Assignee: Kabushiki Kaisha Toshiba, Minato-ku (JP)

(21) Appl. No.: 15/630,401

(22) Filed: Jun. 22, 2017

(30) Foreign Application Priority Data
Jul. 11, 2016 (JP) 2016-137179

(51) Int. Cl. G06F 17/30; G06F 7/14

(52) U.S. Cl. CPC G06F 17/30292; G06F 7/14

(57) ABSTRACT

According to one embodiment, a DB integration device includes a receiver and a designator. The receiver is configured to receive at least a request for combining first data and second data. The designator is configured to designate, from among a plurality of DB systems, a DB system for executing a combining process of combining the first data and the second data on the basis of combining capability information. The combining capability information indicates at least one of: whether or not a first DB system is capable of reading the second data from a second DB system and executing the combining process; and whether or not the first DB system is capable of causing the second DB system to read the first data.

### CROSS-REFERENCE TO RELATED APPLICATION

This application is based upon and claims the benefit of priority from Japanese Patent Application No. 2016-137179, filed Jul. 11, 2016; the entire contents of which are incorporated herein by reference.

### FIELD

Embodiments described herein relate to a database integration device, a database integration method, and a computer program product.

### BACKGROUND

A plurality of data servers cooperate to combine data on the basis of a query received from a client. In relation to this, a method in which an integration server acquires data to be combined from a plurality of data servers and performs a combining process on the acquired data is known. Also, if there are some tables that are homogeneous each other in one data server, a method of causing the data server to perform a combining process by pushing down a query to the data server by an integration server is also known.

Furthermore, a method which is called a semi join method and in which data servers cooperate to combine data and send a response to a client is known. If a first server of a pair of data servers has received a query from a client in the semi-join method, the first data server transmits data to a second data server of the pair of data servers and the second data server performs a combining process, and transmits a combining result to the first data server. The first data server generates a final result on the basis on the combining result received from the second data server and responds to the client. However, the semi-join method is also able to be performed only in a case where databases managed by both data servers are homogeneous each other.

Here, if the combining process is performed by the integration server, the amount of data to be transmitted may increase and there is a possibility of combining processing not being possible at high speeds. Also, if data to be combined is stored in heterogeneous tables, there is a possibility of pushdown not being possible. Furthermore, if data to be combined is stored in the heterogeneous tables, the combining process may not be performed at high speeds since the combining process cannot be performed in the semi join method.

### BRIEF DESCRIPTION OF THE DRAWINGS

FIG. 1 is a diagram illustrating an example of a data providing system 1 in an embodiment.

FIG. 2 is a block diagram illustrating an example of functional configurations of a user terminal 100 and a database (DB) integration server 200 in the embodiment.

FIG. 3 is a diagram illustrating a cooperation state between DB system groups of different types in the embodiment.

FIG. 4 is a diagram illustrating an example of a cooperative map in the embodiment.

FIG. 5 is a diagram illustrating another example of a cooperative map in the embodiment.

FIG. 6 is a diagram illustrating a data flow between a plurality of DB systems 400 based on the cooperative map in the embodiment.

FIG. 7 is a diagram illustrating an example of an operation flow between the DB integration server 200 and the plurality of DB systems 400 based on an execution plan in the embodiment.

FIG. 8 is a diagram illustrating an example of a cooperative map 242 in the embodiment.

FIG. 9 is a diagram illustrating an example of a data flow between a DB integration server (S) and a plurality of DB system groups G1 to G4 in the embodiment.

FIG. 10 is a diagram illustrating an example of a data flow in a case where data to be combined is combined by a DB system serving as a third party in the embodiment.

FIG. 11 is a diagram illustrating an example of a data flow in a case where data to be combined is relayed by a DB system serving as a third party in the embodiment.

FIG. 12 is a diagram illustrating an example of a data flow in a case where data to be combined cannot be combined in a DB system even when a DB system serving as a third party is used in the embodiment.

FIG. 13 is a flowchart illustrating an example of a flow of the entire process in the data providing system 1 in the embodiment.

FIG. 14 is a flowchart illustrating an example of a flow of a process (step S106) of generating an execution plan for executing schema update in the embodiment.

FIG. 15 is a diagram illustrating an example of a cooperative map 242 to be updated in the embodiment.

FIG. 16 is a diagram illustrating operations of the DB integration server 200 and the plurality of DB systems 400 when a DB system 400-3 is added in the embodiment.

FIG. 17 is a flowchart illustrating an example of a flow of a process (step S112) of generating an execution plan of a SELECT statement in the embodiment.

FIG. 18 is a flowchart illustrating an example of a flow of a pushdown determination process (step S308) in the embodiment.

FIG. 19 is a diagram illustrating an example of a cooperative map 242 in the embodiment.

FIG. 20 is a diagram illustrating a relationship between a pair of tables to be combined and a cost to the plurality of DB systems 400 in the embodiment.

FIG. 21 is a flowchart illustrating an example of a flow of a process (step S402) of obtaining a path of data to be combined, a pushdown destination, and the cost in the embodiment.

FIG. 22 is a diagram illustrating a state in which the DB integration server 200 receives a query from the user terminal 100 in Example 1.

FIG. 23 is a diagram illustrating a state of pushing down from the DB integration server 200 to the DB system 400-1 in Example 1.

FIG. 24 is a diagram illustrating a state in which a table T_{B} is read by the DB system 400-1 and a combining result is transmitted to the DB integration server 200 in Example 1.

FIG. 25 is a table illustrating data sizes of a table T_{A}, a table T_{B}, and a combining result in Example 1.

FIG. 26 is a diagram illustrating a state of pushing down from the DB integration server 200 to the DB system 400-1 in Example 2.

FIG. 27 is a diagram illustrating a state in which the DB integration server 200 receives a query from the user terminal 100 in Example 3.

FIG. 28 is a diagram illustrating a state of transmitting an extraction condition from the DB system 400-1 to the DB system 400-2 in Example 3.

FIG. 29 is a diagram illustrating data sizes of a table T_{A}, a table T_{B}, and a combining result in Example 3.

### DETAILED DESCRIPTION

According to one embodiment, a database (DB) integration device includes a receiver, a communicator, a designator, a generator, and an instructor. The receiver is configured to receive at least a request for combining first data and second data. The communicator is configured to communicate with a plurality of DB systems. The plurality of DB systems includes a first DB system and a second DB system. The first DB system includes a first DB storing the first data. The second DB system includes a second DB storing the second data. The designator is configured to designate, from among at least one of the plurality of DB systems, a DB system for executing a combining process of combining the first data and the second data on the basis of combining capability information. The combining capability information indicates at least one of whether or not the first DB system is capable of reading the second data from the second DB system and executing the combining process; and whether or not the first DB system is capable of causing the second DB system to read the first data. The generator is configured to generate an execution plan for causing the DB system designated by the designator to execute the combining process. The instructor is configured to give, on the basis of the execution plan generated by the generator, instructions to the DB system designated by the designator through the communicator.

Hereinafter, a DB integration device, a DB integration method, and a DB integration program of embodiments will be described with reference to the drawings.

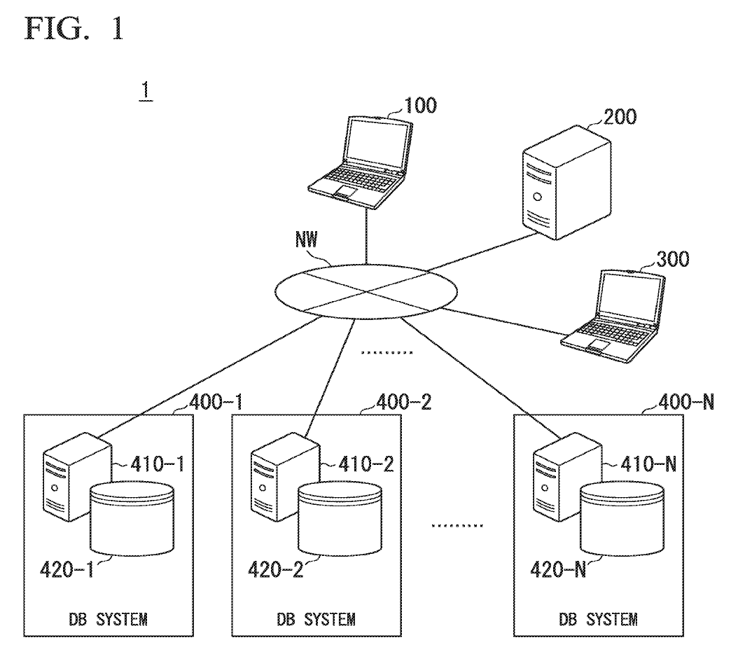

FIG. 1 is a diagram illustrating an example of a data providing system 1 according to an embodiment. For example, the data providing system 1 includes a user terminal 100, a DB integration server 200, a management terminal 300, and a plurality of DB systems 400-1, 400-2, . . . , and 400-N. Hereinafter, if a data source is not distinguished from other data sources, it is referred to as a “DB system 400.” The number of DB systems 400 is not limited. Each DB system 400 manages and stores heterogeneous data inside a DB or between DBs. For example, each DB system 400 manages and stores a plurality piece of data which are heterogeneous each other inside a DB. For example, each DB system 400 manages a data that is heterogeneous from a data that is stored in another DB. Heterogeneous data is, for example, data whose table structure is different.

The user terminal 100, the DB integration server 200, the management terminal 300, and the DB system 400 are connected to a network NW. The network NW includes, for example, a radio base station, a Wi-Fi access point, a communication line, a provider, the Internet, and the like. Also, it is not necessary for all combinations of these constituent elements to be able to communicate with each other, and the network NW may partially include a local network, for example.

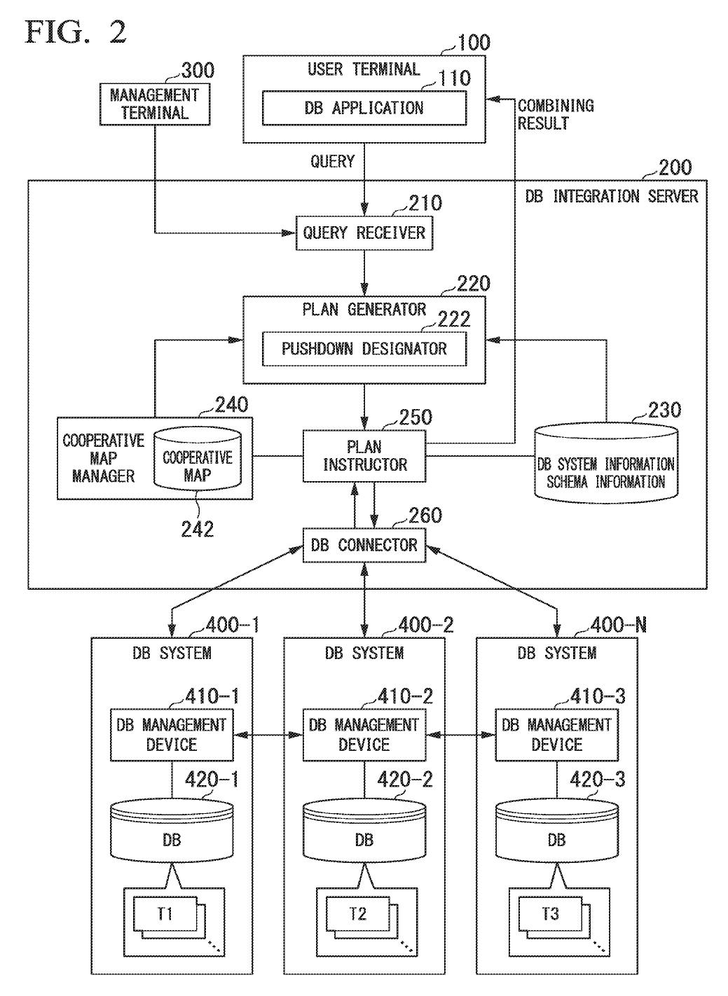

FIG. 2 is a block diagram illustrating an example of functional configurations of the user terminal 100 and the DB integration server 200. The user terminal 100 is a computer in which a DB application 110 is installed. The user terminal 100 is an example of a client for the DB integration server 200. The DB application 110 generates a query described in a structured query language (SQL) on the basis of, for example, a user's operation. In the embodiment, the DB application 110 generates a query for requesting a result of combining data. The query is an example of a request to the DB integration server 200. The query may be another type of request which is not interpreted as belonging to the conceptual category of a query. The DB application 110 transmits the generated query to the DB integration server 200 through a network interface card (NIC). Also, the DB application 110 receives a response to the query from the DB integration server 200.

The DB integration server 200 includes, for example, a query receiver 210, a plan generator 220, a storage unit 230, a cooperative map manager 240, a plan instructor 250, and a DB connector 260. The query receiver 210, the plan generator 220, the cooperative map manager 240, the plan instructor 250, and the DB connector 260 are realized by a processor such as a central processing unit (CPU) executing a program stored in a program memory. Also, some or all of these functional units may be realized by hardware such as large scale integration (LSI), an application specific integrated circuit (ASIC), a field-programmable gate array (FPGA), Graphics Processing Unit (GPU), or the like or may be realized by cooperation of software and hardware. The DB integration server 200 is an example of a DB integration device.

The query receiver 210 and the DB connector 260 are communication interfaces such as the NIC or a wireless communication module. The query receiver 210 is an example of a receiver. The DB connector 260 is an example of a communicator.

The plan generator 220 analyzes the query received by the query receiver 210, and generates an execution plan on the basis of the analysis result. The plan generator 220 includes, for example, a pushdown designator 222. The pushdown designator 222 determines whether or not pushdown is possible. The pushdown is used to cause one of the DB systems 400 to execute a process based on the query by transmitting the query to the one of DB systems 400. The plan generator 220 generates the execution plan on the basis of the determination result of the pushdown designator 222. The execution plan represents a procedure of extracting, from the DB systems 400, the data to be combined that is specified in the query, combining the extracted data to be combined, and responding to the query.

The storage unit 230 is realized by a hard disk drive (HDD), a flash memory, an electrically erasable programmable read only memory (EEPROM), a read only memory (ROM), a random access memory (RAM), or a hybrid type storage device using a plurality of these elements. Also, in the storage unit 230, various programs such as firmware and application programs, processing results, and the like are stored. The storage unit 230 stores DB system information and schema information. The DB system information includes information for accessing the DB systems 400, information about DB management systems (DBMSs) adopted in the DB systems 400, tables (Ts) stored in the DBs 420 provided in the DB systems 400, and information about types of data included in the tables. The schema information is information about structures of the DBs in the DB systems 400.

The cooperative map manager 240 updates a cooperative map 242 on the basis of a query for adding the DB system 400, deleting the DB system 400, or requesting a change in access right from one of the DB systems 400 to another one of the DB systems 400. The query for updating the cooperative map 242 is supplied from the management terminal 300 to the DB integration server 200. The management terminal 300 is an example of an external device.

The cooperative map manager 240 manages the cooperative map 242 on the basis of the request received from the management terminal 300. The cooperative map 242 is an example of combining capability information. The cooperative map 242 indicates whether or not each DB system 400 of a combination of DB systems 400 that includes DBs 420 storing data to be combined that is specified in the query is capable of performing a combining process by reading the data to be combined from the DB system 400 that is a combination partner of the combination of DB systems, and whether or not each DB system 400 of the combination of DB systems 400 is capable of causing the DB system 400 that is the combination partner of the combination of DB systems to read the data to be combined. In other words, for each combination of first and second DB systems 400 among a plurality of DB systems 400, the cooperative map 242 includes: information indicating whether or not the first DB system 400 is capable of combining first data stored in a DB 420 of the first DB system and second data which is stored in a DB 420 of the second DB system and which is acquired by inquiring the second DB system about the second data; and information indicating whether or not the second DB system 400 is capable of combining the second data stored in the DB 420 of the second DB system and the first data which is stored in the DB 420 of the first DB system and which is acquired by inquiring the first DB system about the first data. In the following description, in a set of DB systems 400 for managing the data to be combined, the DB system 400 of a side that reads the data to be combined is referred to as a “reception side DB system 400” and the DB system 400 of a side from which the data to be combined is read is referred to as a “transmission side DB system 400.”

In this embodiment, in the case where a combination (e.g., a pair) of DB systems 400 includes a first DB system 400 and a second DB system 400, the first DB system 400 includes the DB 420 storing a first data, the second DB system 400 includes the DB 420 storing a second data, and the first data and the second data are data to be combined with each other based on the query, the cooperative map 242 indicates at least: whether or not the first DB system 400 is capable of performing a combining process (i.e., combining the first and second data) by reading the second data from the second DB system 400; whether or not the first DB system 400 is capable of causing the second DB system 400 to read the first data; whether or not the second DB system 400 is capable of performing the combining process (i.e., combining the first and second data) by reading the first data from the first DB system 400; and whether or not the second DB system 400 is capable of causing the first DB system 400 to read the second data.

The plan instructor 250 executes a process on the basis of the execution plan generated by the plan generator 220. For example, the plan instructor 250 gives instructions to one of the DB systems on the basis of the execution plan.

The DB system 400-1, . . . , and the DB system 400-N include, for example, a DB management device 410-1, . . . , and a DB management device 410-N and a DB 420-1 . . . , and a DB 420-N. N is a natural number of 3 or more. In the description, a DB management device is written as a “DB management device 410” if the DB management device is not distinguished from other DB management devices and a DB is written as the “DB 420” if the DB is not distinguished from other DBs.

The DB management device 410 is realized by, for example, a processor such as a CPU executing a DBMS stored in a program memory. The DB management device 410 operates the DB 420 and combines the data on the basis of the query received from an external device. The external device is, for example, the DB integration server 200, another DB management device 410, or the management terminal 300.

Also, the DB management device 410 registers schema information corresponding to each of the other DB systems 400 to process data to be combined that is read from the transmission side DB system 400. The DB management device 410 processes the data to be combined that is read from the transmission side DB system 400 with reference to the schema information stored in the internal or external storage unit.

The DB 420 includes a table (T) storing data. The table is information including a record including one or more pieces of data in each row.

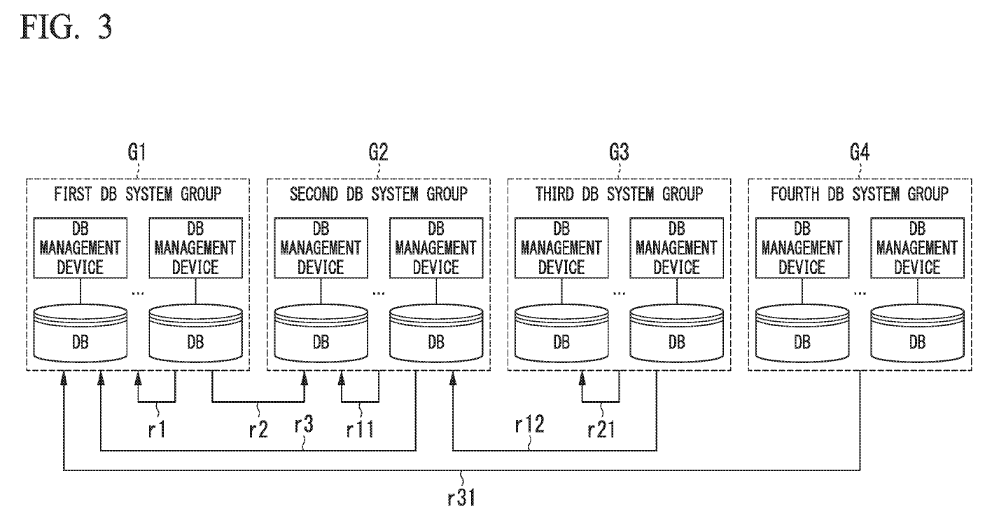

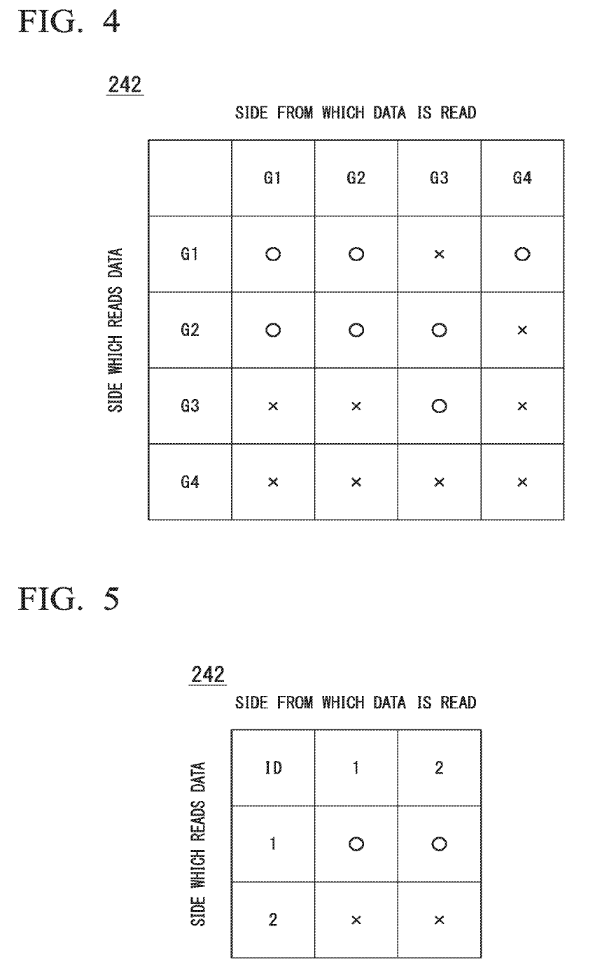

The cooperative map will be described below. FIG. 3 is a diagram illustrating a cooperation state between DB system groups of different types. FIG. 4 is a diagram illustrating an example of a cooperative map. According to a type of DBMS that realizes the DB management device 410, the DB system 400 (subject DB system 400) has cooperation states that are different from each other depending on types of DB system 400 (i.e., a homogeneous DB system 400 and a heterogeneous DB system 400 with respect to the subject DB system). The homogeneous DB system 400 means DB system 400 that is homogeneous to the subject DB system 400, for example. The heterogeneous DB system 400 means DB system 400 that is heterogeneous to the subject DB system 400, for example. The cooperation state means whether or not the DB system (subject DB system 400) is capable of reading the data to be combined from the transmission side DB system 400 or whether or not the DB system (subject DB system 400) is capable of causing the reception side DB system 400 to read data stored in its own DB 420 (DB 420 of the subject DB system 400) due to a difference in the type of DBMSs that realize the DB systems 400.

As illustrated in FIG. 3, the DB system 400 is classified into one of a first DB system group G1, a second DB system group G2, a third DB system group G3, and a fourth DB system group G4. A DB system 400 belonging to the first DB system group G1 can read data from a homogeneous DB system 400 as indicated by a path r1. The DB system 400 belonging to the first DB system group G1 can read data from the DB systems 400 belonging to the second DB system group G2 and can cause the DB systems 400 belonging to the second DB system group G2 to read its own data (i.e., data from the DB system 400 belonging to the first DB system group G1) as indicated by paths r2 and r3. Further, the DB system 400 belonging to the first DB system group G1 can read data from DB systems 400 belonging to the fourth DB system group G4.

A DB system 400 belonging to the second DB system group G2 can read data from a homogeneous DB system 400 as indicated by a path r11. Also, the DB system 400 belonging to the second DB system group G2 can read data from the DB systems 400 belonging to the first DB system group G1 and can cause the DB systems 400 belonging to the first DB system group G1 to read its own data (i.e., data from the DB system 400 belonging to the second DB system group G2) as indicated by the paths r2 and r3. Further, the DB system 400 belonging to the second DB system group G2 can read data from DB systems 400 belonging to the third DB system group G3.

A DB system 400 belonging to the third data system group G3 can read data from a homogeneous DB system 400 as indicated by a path r21. Also, the DB system 400 belonging to the third data system group G3 can cause the DB system 400 belonging to the second DB system group G2 to read its own data (i.e., data from the DB system 400 belonging to the third DB system group G3) as indicated by a path r12.

The DB system 400 belonging to the fourth DB system group G4 can cause the DB system 400 belonging to the first DB system group G1 to read its own data (i.e., data from the DB system 400 belonging to the fourth DB system group G4) as indicated by a path r31.

Such cooperation states between the first to fourth DB system groups can be represented, for example, as a cooperative map 242 in a format as illustrated in FIG. 4. For example, the cooperative map 242 is information indicating whether the cooperation state at a position where a side that reads data and a side from which data is read intersect is possible (O) or impossible (X).

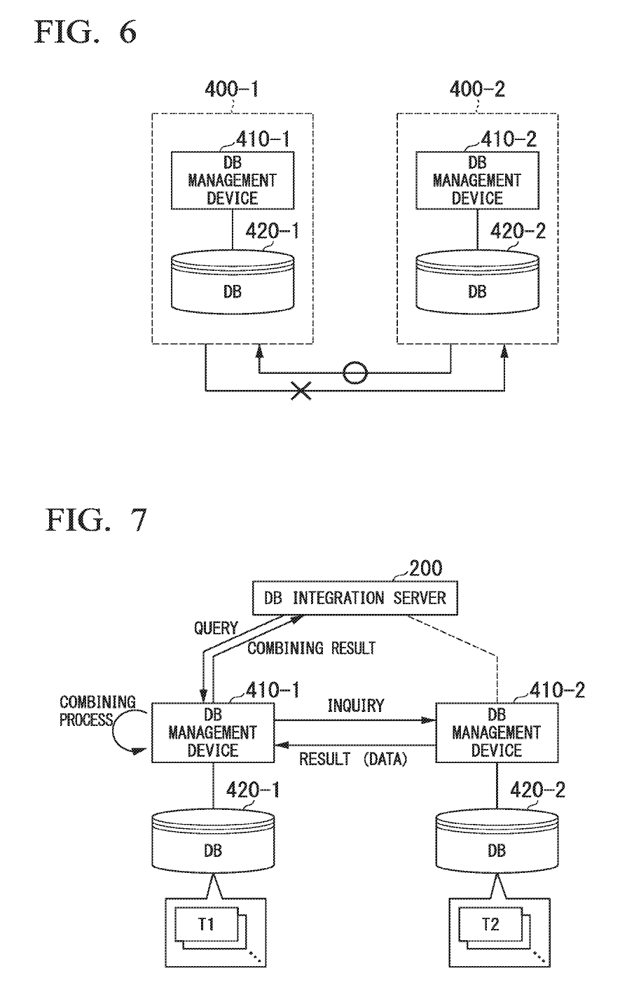

Hereinafter, a process of designating, from among a plurality of DB systems 400, a DB system 400 for executing a combining process of combining data to be combined that is specified in a query on the basis of a cooperative map, generating an execution plan for causing the designated DB system 400 to execute the combining process, and transmitting information based on the query to the designated DB system 400 on the basis of the generated execution plan will be described. FIG. 5 is a diagram illustrating another example of a cooperative map. FIG. 6 is a diagram illustrating a data flow between DB systems 400 based on the cooperative map. FIG. 7 is a diagram illustrating an example of an operation flow between the DB integration server 200 and the plurality of DB systems 400 based on an execution plan.

As illustrated in FIG. 6, the cooperative map illustrated in FIG. 5 indicates that the DB system 400-1 can read data from the DB system 400-2, but the DB system 400-2 cannot read data from the DB system 400-1. In this case, the plan generator 220 executes pushdown from the DB integration server 200 to the DB management device 410-1 and generates an execution plan for performing a combining process on data to be combined in the DB management device 410-1.

The plan instructor 250 executes pushdown on the DB management device 410-1 on the basis of the execution plan. If the DB management device 410-1 has received the pushed-down query, the DB management device 410-1 sends an inquiry to the DB management device 410-2. In response to the inquiry, the DB management device 410-2 extracts the data to be combined from the DB 420-2, and transmits the data to be combined as a result of the extraction to the DB management device 410-1. The DB management device 410-1 executes a combining process of combining the data to be combined that is acquired from the DB management device 410-2 and the data to be combined that is stored in the DB 420-1 of the DB management device 410-1. The DB management device 410-1 transmits a combining result to the DB integration server 200.

Hereinafter, a process of combining data to be combined using a DB system 400 serving as a third party if each of two DB systems 400 of the combination of the DB systems 400 including the DBs 420 storing the data to be combined that is specified in the query cannot read the data to be combined from the DB system 400 that is the combination partner (e.g., in the case where the a combination (e.g., a pair) of DB systems 400 includes a first DB system 400 and a second DB system 400, the first DB system 400 includes the DB 420 storing a first data, the second DB system 400 includes the DB 420 storing a second data, the first data and the second data are data to be combined with each other based on the query, the first DB system 400 cannot read the second data from the second DB system 400, and the second system 400 cannot read the first data from the first DB system 400) will be described. The DB system serving as the third party is a DB system 400 other than a set of DB systems 400 that manage the data to be combined.

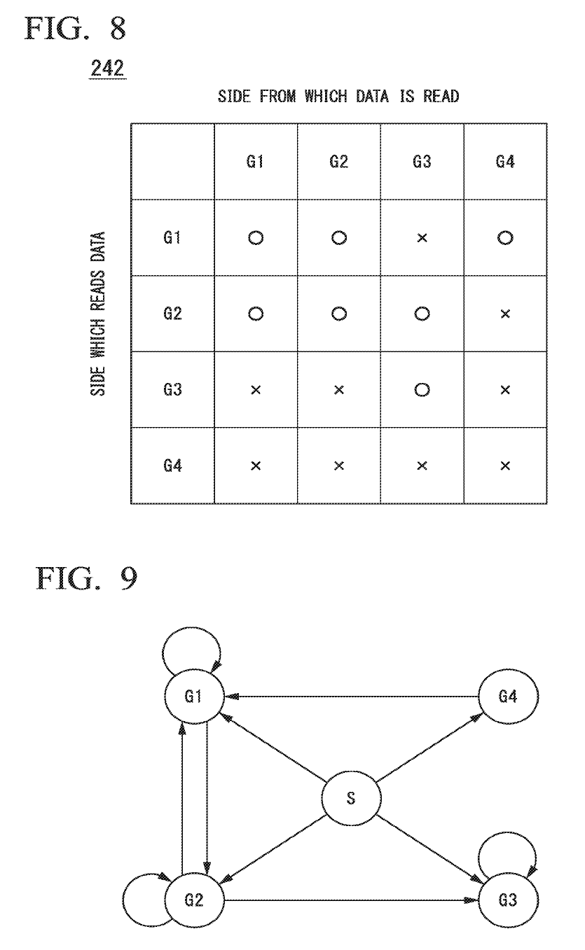

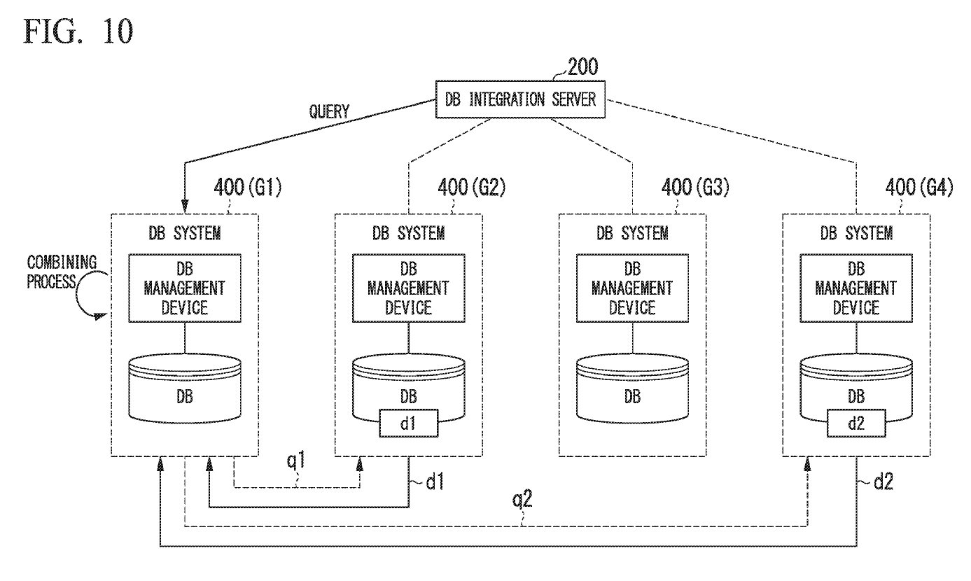

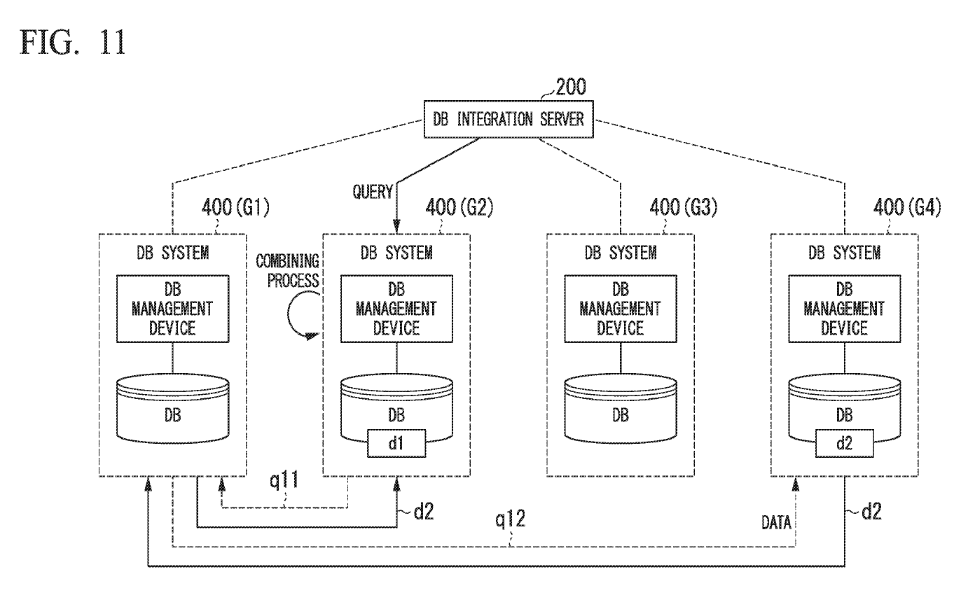

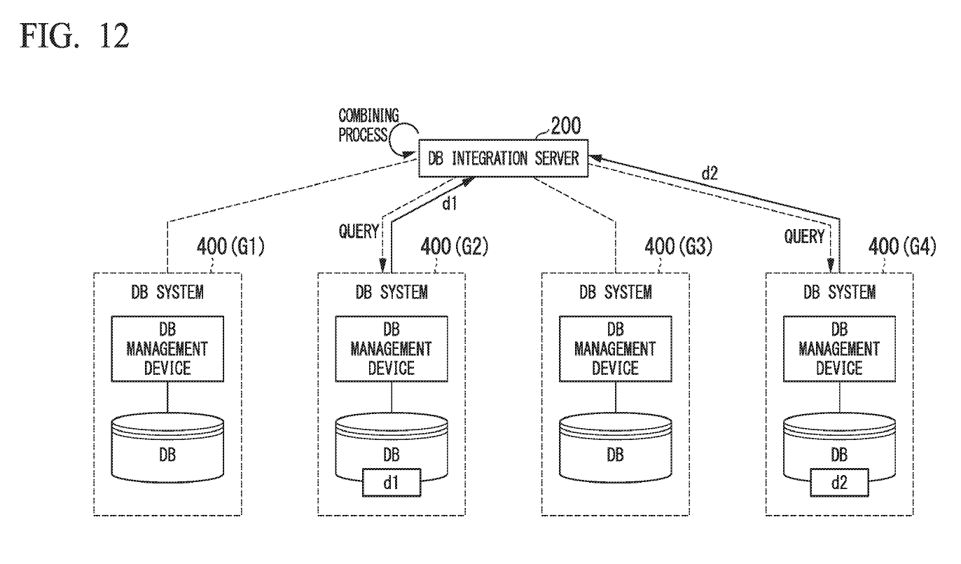

FIG. 8 is a diagram illustrating an example of the cooperative map 242. FIG. 9 is a diagram illustrating an example of a data flow in a DB integration server (S) and DB system groups G1 to G4. FIG. 10 is a diagram illustrating an example of a data flow when data to be combined is combined by a DB system serving as a third party. FIG. 11 is a diagram illustrating an example of a data flow when data to be combined is relayed by a DB system serving as a third party. FIG. 12 is a diagram illustrating an example of a data flow when data to be combined cannot be combined in a DB system even when a DB system serving as a third party is used.

The cooperative map 242 as illustrated in FIG. 8 can be represented as a directed graph as illustrated in FIG. 9.

As illustrated in FIG. 10, data to be combined (d1 and d2) that is specified in the query is assumed to be stored in the DB system 400 (G2) belonging to G2 and the DB system 400 (G4) belonging to G4. The pushdown designator 222 determines that each DB system of the set of DB systems 400 (400 (G2) and 400 (G4)) storing d1 and d2 cannot acquire data to be combined from the DB system that is the combination partner with reference to the cooperative map 242. In this case, the pushdown designator 222 searches for the DB system 400 (G1) belonging to G1 capable of acquiring d1 and d2 from the set of DB systems 400 (G2) and 400 (G4). The pushdown designator 222 designates the DB system 400 (G1) as the DB system 400 that performs the combining process.

Furthermore, the plan generator 220 generates an execution plan in which the found DB system 400 (G1) acquires d1 and d2 from two DB systems of the set of the DB systems 400 (G2) and 400 (G4) and performs the combining process. The plan instructor 250 transmits a query to the DB system 400 (G1) on the basis of the generated execution plan. The DB system 400 (G1) acquires d1 by transmitting an inquiry q1 based on the query to the DB system 400 (G2). The DB system 400 (G1) acquires d2 by transmitting an inquiry q2 based on the query to the DB system 400 (G4). The DB system 400 (G1) combines d1 and d2 and returns a combining result to the DB integration server 200.

As illustrated in FIG. 11, data to be combined (d1 and d2) that is specified in the query is assumed to be stored in the DB system 400 (G2) belonging to G2 of one set and the DB system 400 (G4) belonging to G4. The pushdown designator 222 determines that each DB system of a combination of DB systems (400 (G2) and 400 (G4)) of the set of DB systems 400 storing d1 and d2 cannot acquire data to be combined from the DB system that is the combination partner with reference to the cooperative map 242. In this case, the pushdown designator 222 searches for the DB system 400 (G1) that acquires d2 from one DB systems 400 (G4) of the one set and relays d2 to the other DB system 400 (G2) of the one set. The pushdown designator 222 designates the DB system 400 (G2) as the DB system 400 which performs the combining process.

Furthermore, the plan generator 220 generates an execution plan in which the found DB system 400 (G1) acquires d2 from the DB system 400 (G4) and relays d2 to the DB system 400 (G2), and the DB system 400 (G2) performs the combining process. The plan instructor 250 transmits a query to the DB system 400 (G2) on the basis of the generated execution plan. The DB system 400 (G2) transmits an inquiry q11 based on the query to the DB system 400 (G1). According to the reception of q11, the DB system 400 (G1) acquires d2 from the DB system 400 (G4) by transmitting the query q12 to the DB system 400 (G4). According to the acquisition of d2, the DB system 400 (G1) transmits d2 to the DB system 400 (G2). The DB system 400 (G2) combines d1 and d2 and returns a combining result to the DB integration server 200.

Also, if each DB system of a set of DB systems 400 (400 (G2) and 400 (G4)) storing d1 and d2 cannot acquire the data to be combined from the DB system 400 that is the combination partner, the DB integration server 200 may determine that the query is not pushed down to the DB system 400. If the pushdown is not performed, the DB integration server 200 transmits a query for extracting dl to the DB system 400 (G2) and transmits a query for extracting d2 to the DB system 400 (G4) as illustrated in FIG. 12. Thereby, the DB integration server 200 acquires d1 and d2 and combines dl and d2.

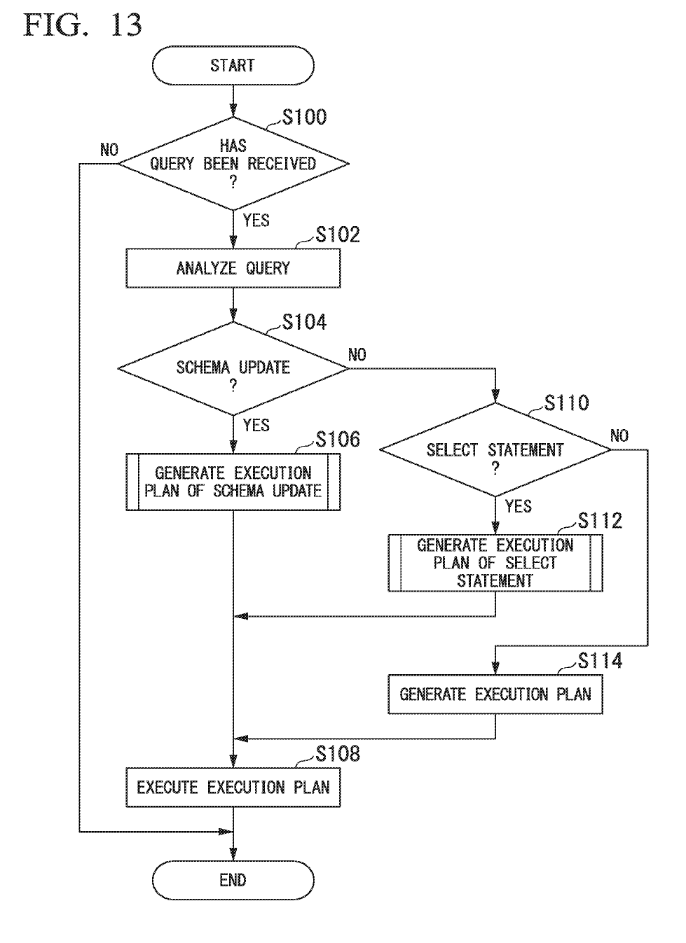

Hereinafter, the flow of a process in the above-described data providing system 1 will be described. FIG. 13 is a flowchart illustrating an example of a flow of the entire process in the data providing system 1.

First, the DB integration server 200 determines whether or not a query has been received (step S100). If a query has been received, the DB integration server 200 analyzes the query (step S102), and determines whether or not the query requests schema update (step S104). The schema update includes registration or deletion of a schema or a change in access rights (e.g., at least one of giving and taking an access right from one of the plurality of DB systems to another one of the plurality of DB systems). The schema registration includes, for example, addition of a new DB system 400, a table, or data. The schema deletion includes, for example, deletion of a DB system 400, a table, or data. The change in the access rights is to change whether reading of data is allowed between the DB systems 400.

If the query requests the schema update, the DB integration server 200 generates an execution plan for executing the schema update (step S106) and executes the execution plan (step S108). If the query does not request the schema update, the DB integration server 200 determines whether or not the query is a SELECT statement (step S110). If the query is a SELECT statement, the DB integration server 200 generates an execution plan of the SELECT statement (step S112) and executes the execution plan (step S108). If the query is not a SELECT statement, the DB integration server 200 generates an execution plan on the basis of a result of analyzing the query (step S114) and executes the execution plan (step S108). The above is a description of the entire process of the data providing system 1.

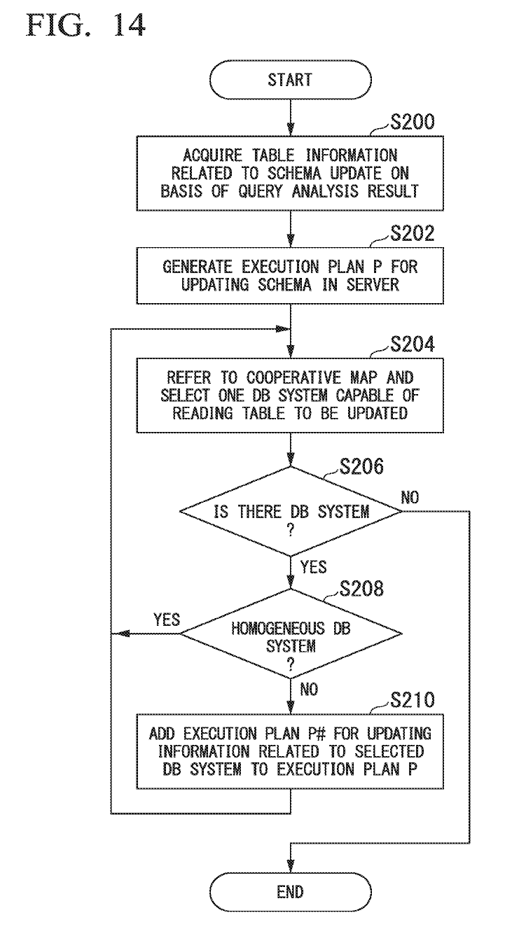

FIG. 14 is a flowchart illustrating an example of a flow of a process (step S106) for generating an execution plan for executing schema update. First, the plan generator 220 acquires table information of a schema update target on the basis of the analysis result of the query (step S200). The table information is assumed to include information for specifying the DB system 400, the type of DBMS in the DB system 400, schema information, and the like. Next, the plan generator 220 generates an execution plan P for updating the cooperative map 242, the DB system information, the schema information, etc. in the DB integration server 200 on the basis of the table information (step S202).

Next, the plan generator 220 refers to the cooperative map 242 and selects one DB system 400 capable of reading a table of a schema update target (step S204).

The plan generator 220 determines whether or not there is a DB system 400 capable of reading the table of the schema update target (step S206). If there is no such DB system 400, the plan generator 220 terminates the process of this flowchart. If there is such a DB system 400, the plan generator 220 determines whether or not the selected DB system 400 is a DB system having the same type as the DB system 400 that manages the schema update target table (step S208). If there is a homogeneous DB system 400, the plan generator 220 does not need to change information in the homogeneous DB system 400, and therefore returns the process to step S204.

If there is no homogeneous DB system 400, the plan generator 220 adds an execution plan P# for registering or deleting information in the selected DB system 400 to the execution plan P.

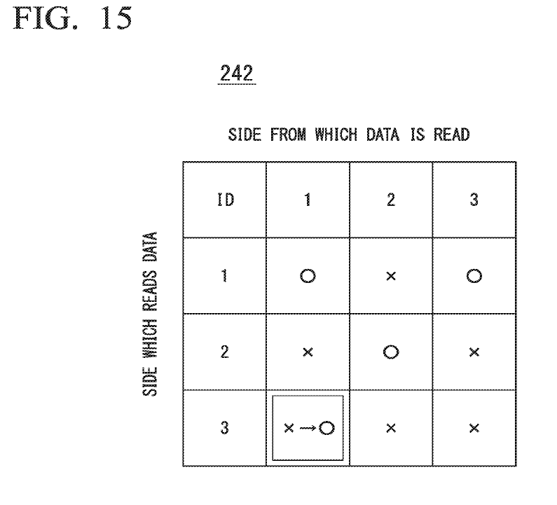

FIG. 15 is a diagram illustrating an example of the cooperative map 242 to be updated. If the query indicates that the cooperative map 242 is updated so that the DB system 400-3 can read the table of the DB system 400-1, the plan generator 220 generates the execution plan P for updating the cooperation state at an intersection between the reception side DB system 400-3 and the transmission side DB system 400-1 in the cooperative map 242 from impossible (X) to possible (O). Also, the plan generator 220 adds the execution plan P# for permitting the DB system 400-1 to allow a table to be read by the DB system 400-3 to the execution plan P. Furthermore, the plan generator 220 adds the execution plan P# to the execution plan P for permitting the DB system 400-3 to read the table from the DB system 400-1.

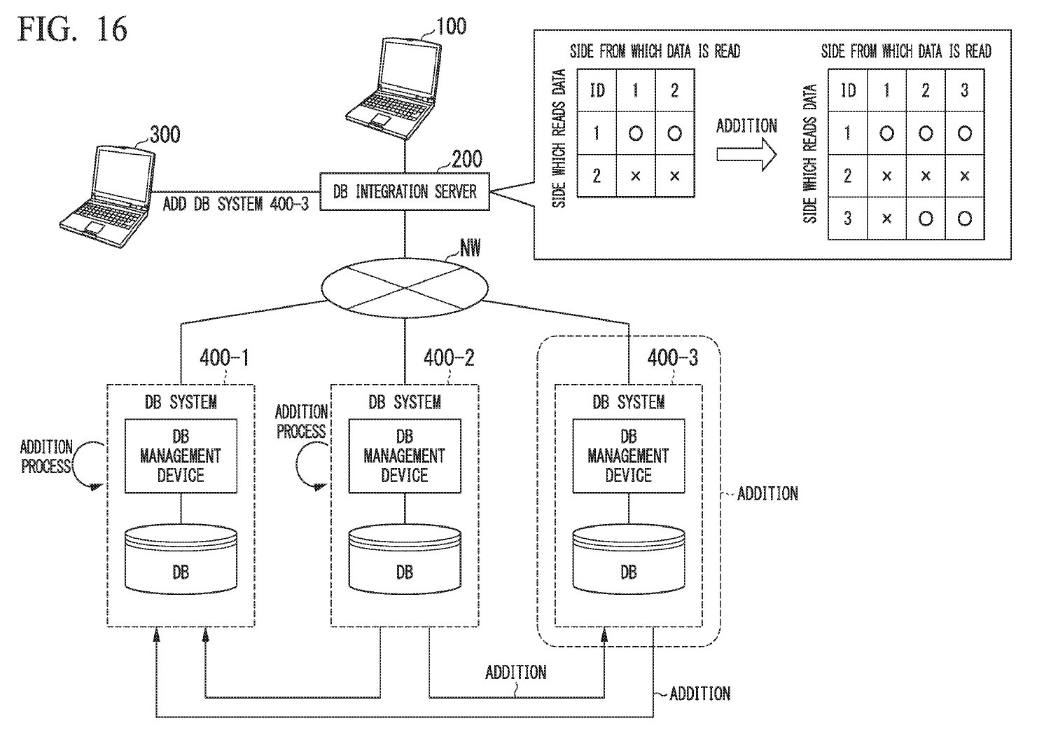

FIG. 16 is a diagram illustrating operations of the DB integration server 200 and the DB system 400 when the DB system 400-3 is added. If the query indicating that the “DB system 400-3 is added” has been received from the management terminal 300, the DB integration server 200 generates an execution plan P for updating the cooperative map 242 on the basis of the analysis result of the query. Furthermore, the DB integration server 200 adds an execution plan P# for adding information for reading a table with the DB system 400-3 in the DB systems 400-1 and 400-2 whose types are different from that of the DB system 400-3 (step S210).

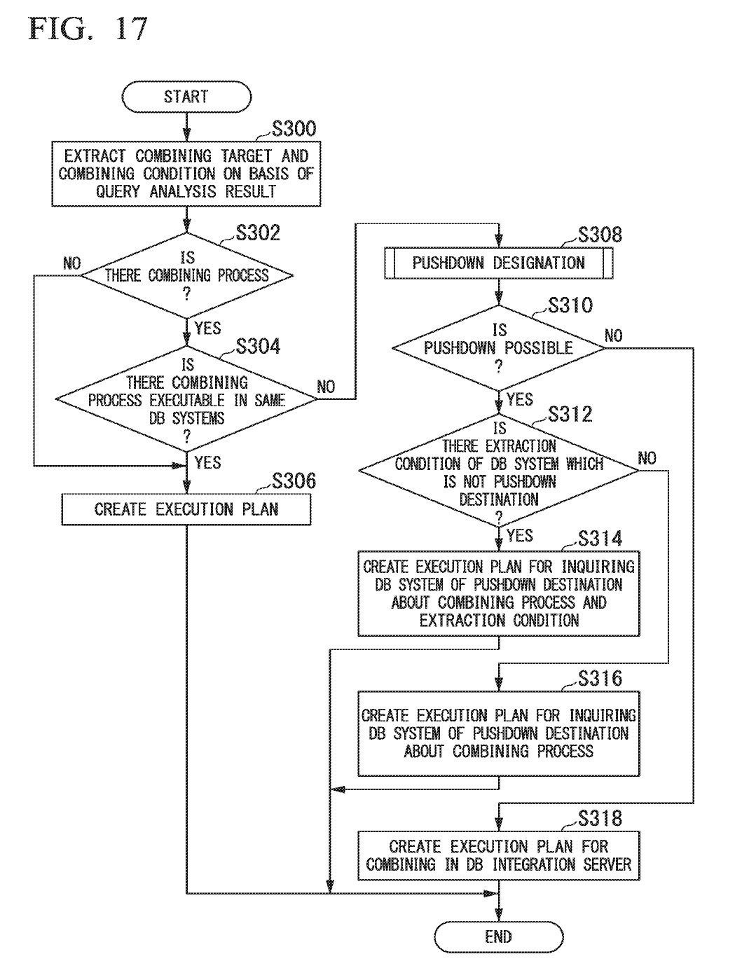

FIG. 17 is a flowchart illustrating an example of a flow of a process (step S112) of generating an execution plan of a SELECT statement. First, the plan generator 220 extracts a combining target table (DB 420) and a combining condition on the basis of a query analysis result (step S300). Next, the plan generator 220 determines whether or not there is a combining process in a process of sending a response of a result to the query on the basis of the extracted information (step S302). If there is no combining process, the plan generator 220 creates an execution plan of another process for responding to the query (step S306).

If there is a combining process, the plan generator 220 determines whether or not there is the combining process executable in the same DB system in a set of DB systems 400 having a table (or tables) described after a FROM clause in a SELECT statement (step S304). If there is a combining process executable in the same DB system 400, the plan generator 220 creates an execution plan for executing the combining process in the DB system 400 (step S306).

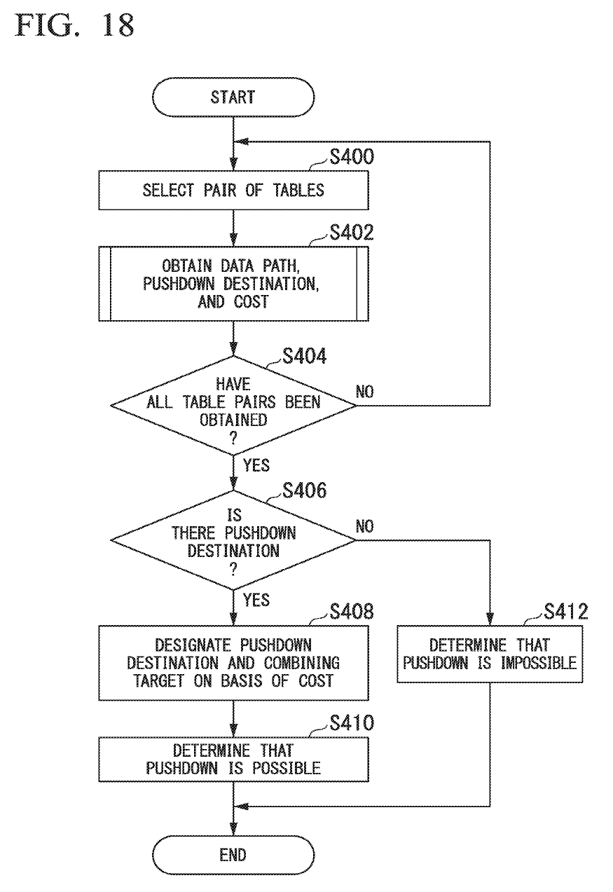

Next, the pushdown designator 222 makes a pushdown determination (step S308). Also, processing content of the pushdown determination will be described with reference to FIG. 18. The plan generator 220 determines whether pushdown is possible as a result of the pushdown determination (step S310). If pushdown is possible, the plan generator 220 determines whether or not there is an extraction condition to be executed in the DB system 400 (the transmission side DB system 400) that is not the pushdown destination in a set of DB systems 400 (step S312). The extraction condition is a condition for extracting data to be combined that is described after a WHERE clause in the SELECT statement.

If there is the extraction condition, the plan generator 220 executes the combining process on the DB system 400 (the reception side DB system 400) selected as the pushdown destination and creates an execution plan for inquiring the transmission side DB system 400 about the extraction condition (step S314). The execution plan for executing the combining process includes a process of acquiring data to be combined from the transmission side DB system 400. If there is no extraction condition, the plan generator 220 creates an execution plan for executing the combining process on the reception side DB system 400 (step S316).

If the pushdown is impossible, the plan generator 220 creates an execution plan for executing the combining process in the DB integration server 200 (step S318).

FIG. 18 is a flowchart illustrating an example of the flow of the pushdown determination process (step S308). First, the pushdown designator 222 selects one pair among tables described after a FROM clause in a SELECT statement (step S400). The pushdown designator 222 selects, for example, a pair of tables in the order of occurrence in the FROM clause. Next, the pushdown designator 222 obtains a path, a pushdown destination, and a cost for transmitting the data to be combined that is extracted from the table from the transmission side DB system 400 to the reception side DB system 400 (step S402). The content of the process for obtaining the data path, the pushdown destination, and the cost will be described below.

Next, the pushdown designator 222 determines whether or not the data path, the pushdown destination, and the cost have been obtained for all pairs of tables (step S404). If the pushdown designator 222 has not determined pushdown destinations for all the pairs of tables, the pushdown designator 222 returns the process to step S400.

If pushdown destinations for all pairs of tables have been determined, the pushdown designator 222 determines whether or not there is a pushdown destination (step S406). If there is a pushdown destination, the pushdown designator 222 designates the pushdown destination and the tables that are the combining targets on the basis of cost information (step S408).

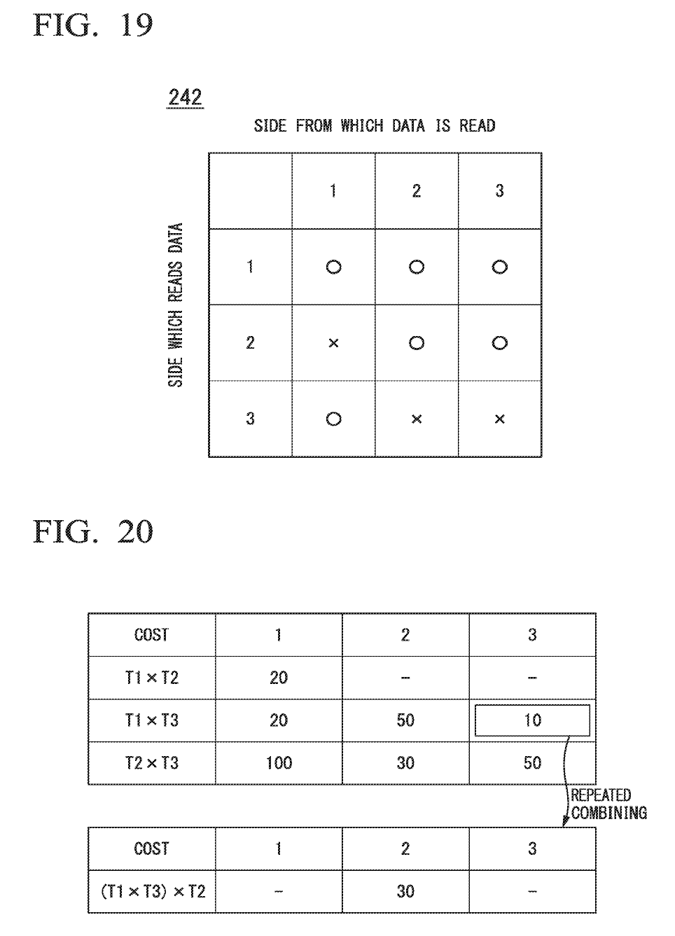

FIG. 19 is a diagram illustrating an example of the cooperative map 242. FIG. 20 is a diagram illustrating a relationship between a pair of tables to be combined and a cost of the DB system 400. The DB integration server 200 is assumed to have received a query for combining data extracted from a set of tables T1, T2, T3. The table T1 is a table managed by the DB system 400-1, T2 is a table managed by the DB system 400-2, and T3 is a table managed by the DB system 400-3. The pushdown designator 222 calculates the cost of combining the data to be combined that is extracted from the tables for each DB system 400. As a result of calculating the cost as shown in the upper diagram of FIG. 20, the plan generator 220 determines that the cost of combining data extracted from the table T1 and data extracted from the table T3 is minimized.

Next, the pushdown designator 222 determine that it is possible to push down a query for combining the data extracted from the table T2 to the result of combining the data extracted from the table T1 and the data extracted from the table T3 to the DB system 400-2 with reference to the cooperative map 242. Then, as illustrated in the lower diagram of FIG. 20, the plan generator 220 calculates the cost for combining the data extracted from the table T2. In this case, because the DB system 400 that is capable of being the pushdown destination is only the DB systems 400-2, the pushdown designator 222 designates the DB system 400-2 as the pushdown destination.

If there is no pushdown destination, the pushdown designator 222 determines that pushdown is impossible (step S412).

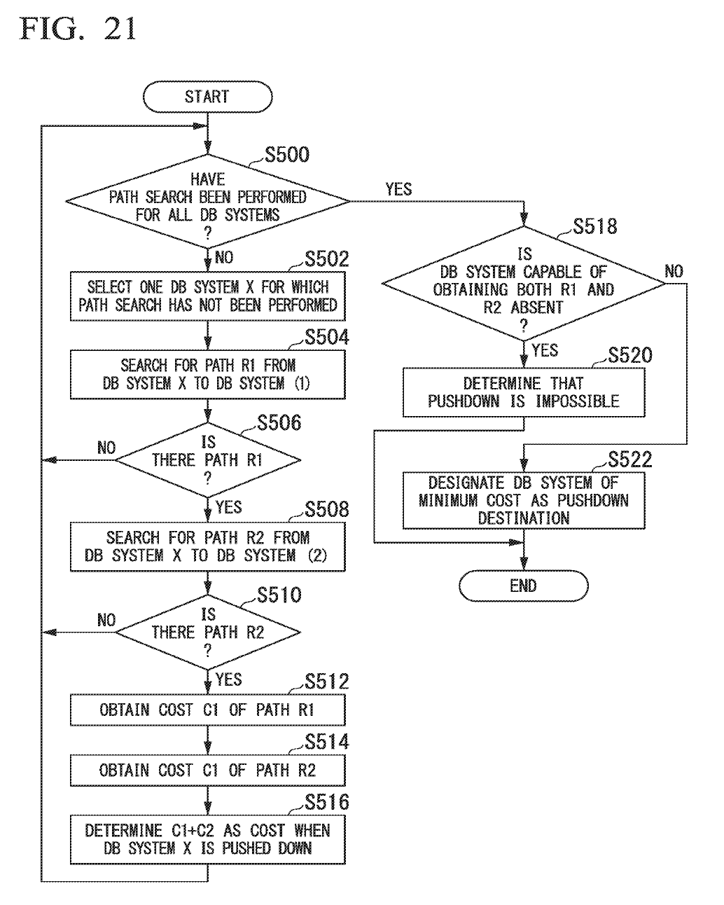

FIG. 21 is a flowchart illustrating an example of a flow of a process (step S402) of obtaining a path of data to be combined, a pushdown destination, and a cost. First, the pushdown designator 222 determines whether or not path search has been performed for all DB systems 400 (step S500).

If path search has not been performed for all the DB systems 400, the pushdown designator 222 selects one DB system X for which path search has not been performed (step S502). Next, the pushdown designator 222 searches for a path R1 from the selected DB system X to the DB system (P1) that manages one table of a pair of tables (step S504). The pushdown designator 222 determines whether or not there is a path R1 from the DB system X to the DB system (P1) (step S506). If there are a plurality of paths R1, the pushdown designator 222 obtains the plurality of paths R1. If there is no path R1, the pushdown designator 222 returns the process to step S500.

If there is a path R1, the pushdown designator 222 searches for a path R2 from the DB system X to the DB system (P2) that manages the other table of the pair of tables (step S508). The pushdown designator 222 determines whether or not there is a path R2 from the DB system X to the DB system (P2) (step S510). If there are a plurality of paths R2, the pushdown designator 222 obtains the plurality of paths R2. If there is no path R2, the pushdown designator 222 returns the process to step S500.

Next, the pushdown designator 222 obtains the cost C1 of the path R1 (step S512). Next, the pushdown designator 222 obtains the cost C2 of the path R2 (step S514). The cost is information indicating static indices such as performance and a network bandwidth of the DB system 400 and dynamic indices such as a processing load in the DB system 400 capable of executing the combining process and/or an amount of data to be combined which is specified in a query and which is transmitted in the executing the combining process.

Next, the pushdown designator 222 determines a cost obtained by summing the costs C1 and C2 as a cost of the case of pushing down to the DB system X (step S516), and returns the process to step S500.

Next, when it is determined that path search has been performed for all the DB systems 400, the pushdown designator 222 determines whether or not a DB system 400 capable of obtaining both of the paths R1 and R2 is absent (step S518). That is, the pushdown designator 222 determines whether or not a DB system 400 capable of being traced to both the DB system (P1) and the DB system (P2) is absent. If there is no DB system 400 capable of obtaining both the paths R1 and R2, the pushdown designator 222 determines that pushdown is impossible (step S520). When there is a DB system 400 capable of obtaining both the paths R1 and R2, the pushdown designator 222 designates the DB system 400 having the minimum cost as the pushdown destination (step S522).

According to the DB integration server 200 of the above-described embodiment, since a DB system 400 for executing the combining process is designated from among the plurality of DB systems 400 on the basis of the cooperative map 242 and information based on the query is transmitted to the designated DB system 400, it is possible to execute the pushdown to the DB system 400 capable of performing the combining process even when the data to be combined is managed by a heterogeneous DB system 400. Thereby, according to the DB integration server 200, even when the data to be combined is managed by the heterogeneous DB system 400, it is possible to execute the combining process at a higher speed if there is a DB system 400 capable of performing the combining process by acquiring data to be combined from the heterogeneous DB system 400. That is, according to the DB integration server 200, it is possible to execute the combining process at a higher speed by suppressing the data amount of communication because it is unnecessary to receive the data to be combined from the DB system 400. Also, according to the DB integration server 200, it is possible to suppress a frequency at which the combining process is performed by the DB integration server 200 and it is possible to suppress the processing load.

Also, according to the DB integration server 200, it is unnecessary to push down the extraction condition from the DB integration server 200 to the transmission side DB system 400 since the DB system 400 as the pushdown destination transmits the extraction condition of the data to be combined to the transmission side DB system 400. Thereby, the processing load of the DB integration server 200 can be further suppressed.

Furthermore, according to the DB integration server 200, it is possible to suppress a processing delay or a communication delay in the DB system 400 that is the pushdown destination since it is possible to designate the DB system 400 that is the pushdown destination on the basis of the cost information. As a result it is possible to perform the combining process at a higher speed.

Furthermore, according to the DB integration server 200, it is possible to designate a DB system 400 capable of acquiring the data to be combined from two DB systems of a combination as the DB system 400 that is the pushdown destination if the each of two DB systems of the combination of the DB systems 400 for managing the data to be combined cannot acquire the data to be combined from the DB system 400 that is the combination partner. Thereby, according to the DB integration server 200, it is possible to increase a frequency at which the combining process can be performed at a higher speed.

Furthermore, according to the DB integration server 200, it possible to designate a DB system capable of acquiring data to be combined from one DB system that is the combination and relaying the data to be combined to the other DB system of the combination as the DB system 400 that is the pushdown destination if each of two DB systems of the combination of the DB systems 400 for managing the data to be combined cannot acquire the data to be combined from the DB system 400 that is the combination partner. Thereby, according to the DB integration server 200, it is possible to increase a frequency at which the combining process can be performed at a higher speed.

Furthermore, according to the DB integration server 200, it is possible to increase a frequency at which the combining process can be performed at a higher speed since it is possible to designate a DB system 400 which executes the combining process on the basis of a cost if a process of combining data to be combined and repeatedly combining data to be combined to the combined data is executed.

Furthermore, according to the DB integration server 200, it is possible to dynamically update the cooperative map 242 and the cooperation states between the DB systems 400 since an execution plan for updating the cooperative map 242 and an execution plan for changing information for allowing a DB system 400 to access another DB system 400 are generated if a query for adding or deleting a DB system 400 or changing access right between the DB systems 400 has been received.

### EXAMPLES

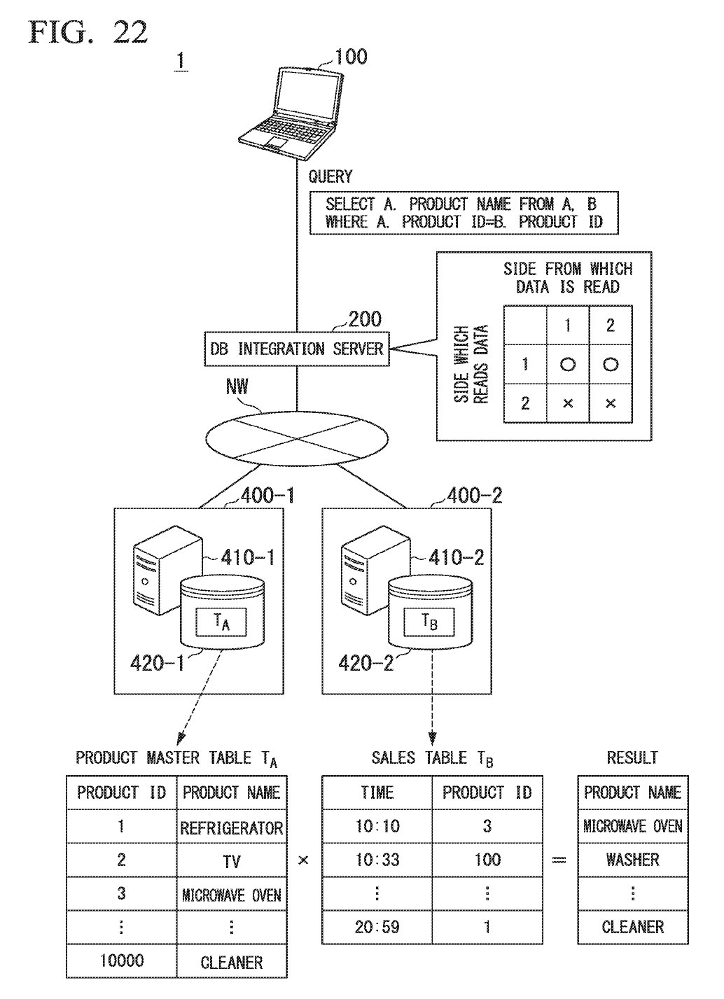

Hereinafter, Example 1 will be described. FIG. 22 is a diagram illustrating a state in which the DB integration server 200 receives a query from the user terminal 100 in Example 1. It is assumed that a product master table T_{A} is stored in the DB 420-1 and a sales table T_{B} is stored in the DB 420-2. When the user wishes to know the names of products sold on a given day, the DB integration server 200 is assumed to receive a query including the following SELECT statement from the user terminal 100.

SELECT A. PRODUCT NAME FROM A, B WHERE A. PRODUCT ID=B. PRODUCT ID

By interpreting the query, the DB integration server 200 generates an execution plan for searching for the product name satisfying the extraction condition that the product ID be the same in the product master table T_{A} and the sales table T_{B}. Also, the DB integration server 200 determines that the DB system 400-1 can read data from the DB system 400-2, but the DB system 400-2 cannot read data from the DB system 400-1, with reference to the cooperative map 242.

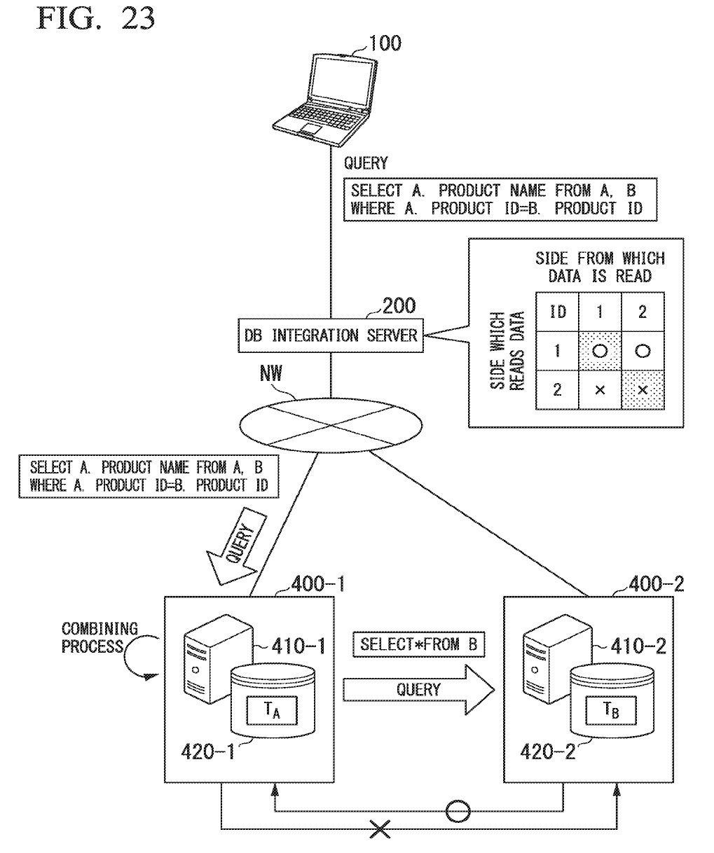

As a result, the DB integration server 200 designates the DB system 400-1 as the DB system 400 that is the pushdown destination. FIG. 23 is a diagram illustrating a state of pushing down from the DB integration server 200 to the DB system 400-1. The DB system 400-1 reads the sales table T_{B} from the DB system 400-2 by sending an inquiry including a query “SELECT*FROM B” to the DB system 400-2.

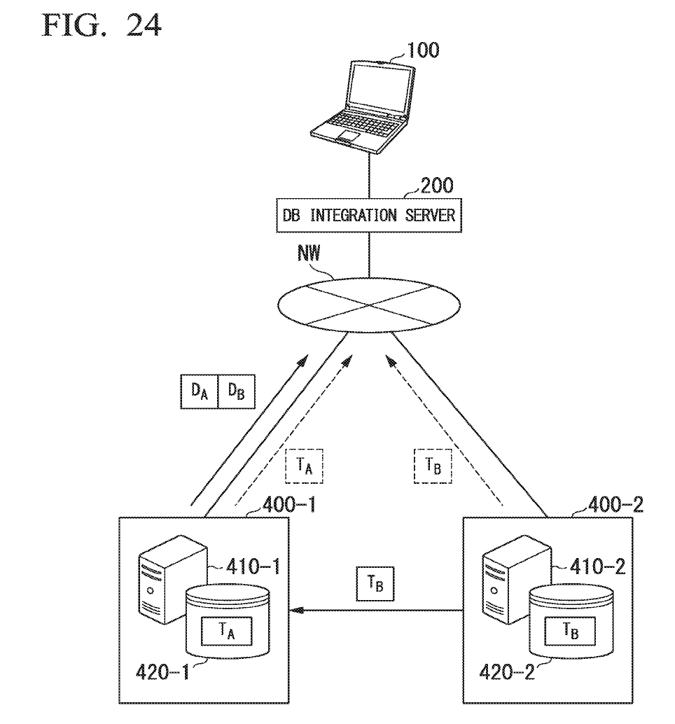

FIG. 24 is a diagram illustrating a state in which the sales table T_{B} is read by the DB system 400-1 and a combining result is transmitted to the DB integration server 200. The DB system 400-1 transmits the product name (e.g., a set of product names) to the DB integration server 200 as a result of combining the product master table T_{A} and the read sales table T_{B}. The product name is an example of the result of combining data D_{A} included in the product master table T_{A} and data D_{B} included in the sales table T_{B}. In FIG. 24, a flow of a table of a comparative example is indicated by a dotted line. In the comparative example, the DB integration server 200 reads a table from each of the DB system 400-1 and the DB system 400-2 and a combining process is executed by the DB integration server 200.

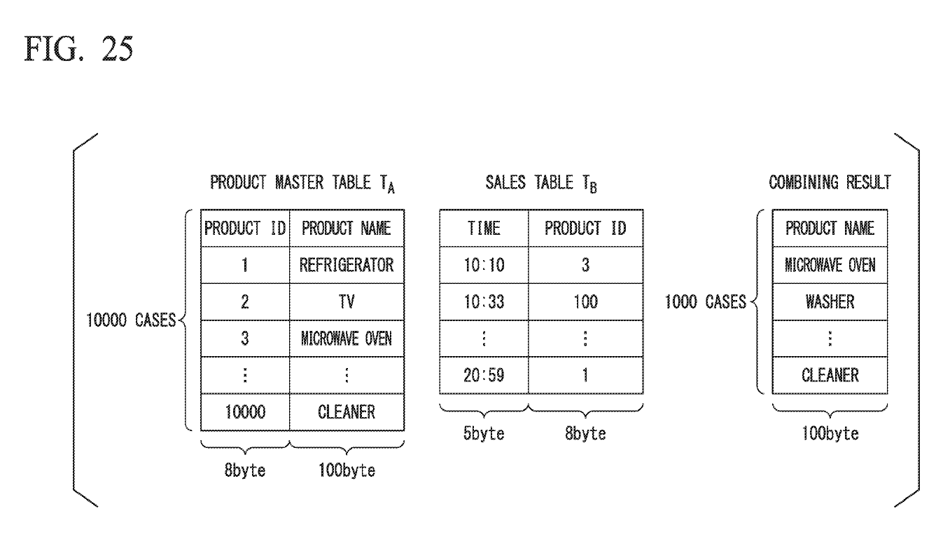

FIG. 25 is a table illustrating data sizes of the product master table T_{A}, the sales table T_{B}, and the combining result in Example 1. In Example 1, it is assumed that the data size of the product master table T_{A} is 1080 KB, the data size of the sales table T_{B} is 13 KB, and the data size of the combining result is 100 KB. In this case, an amount of data transmission in Example 1 is 113 KB, which is the sum of the data size of the sales table T_{B} and the data size of the combining result. In contrast, an amount of transmission of data in the comparative example is 1093 KB, which is the sum of the data size of the product master table T_{A} and the data size of the sales table T_{B}. As described above, according to Example 1, it is possible to suppress the amount of transmission more than in the comparative example.

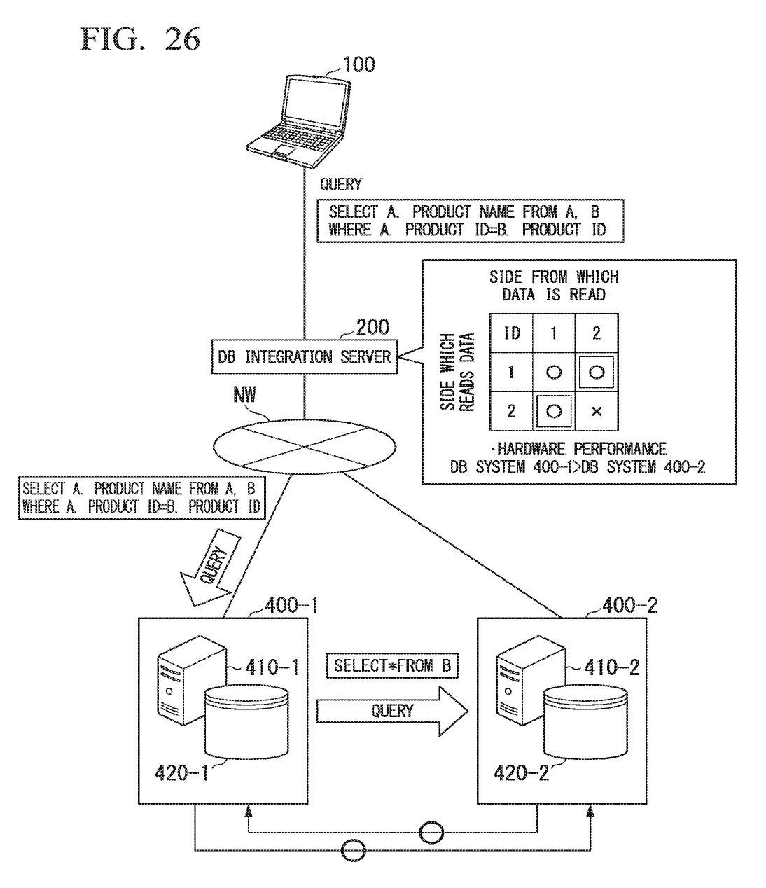

Next, Example 2 will be described. FIG. 26 is a diagram illustrating a state of pushing down from the DB integration server 200 to the DB system 400-1 in Example 2. As in Example 1, the DB integration server 200 receives a query including the following SELECT statement.

SELECT A. PRODUCT NAME FROM A, B WHERE A. PRODUCT ID=B. PRODUCT ID

The DB integration server 200 determines that the DB system 400-1 can read data from the DB system 400-2 and the DB system 400-2 can also read data from the DB system 400-1 with reference to the cooperative map 242. In this case, the DB integration server 200 designates that hardware performance of the DB system 400-1 is higher than that of the DB system 400-2 by comparing the hardware performance stored as DB system information with each other.

As a result, the DB integration server 200 designates the DB system 400-1 as the DB system 400 that is the pushdown destination. The DB system 400-1 executes the combining process as in Example 1, and transmits the combining result to the DB integration server 200. According to Example 2, it is possible to suppress the amount of transmission more than in the comparative example.

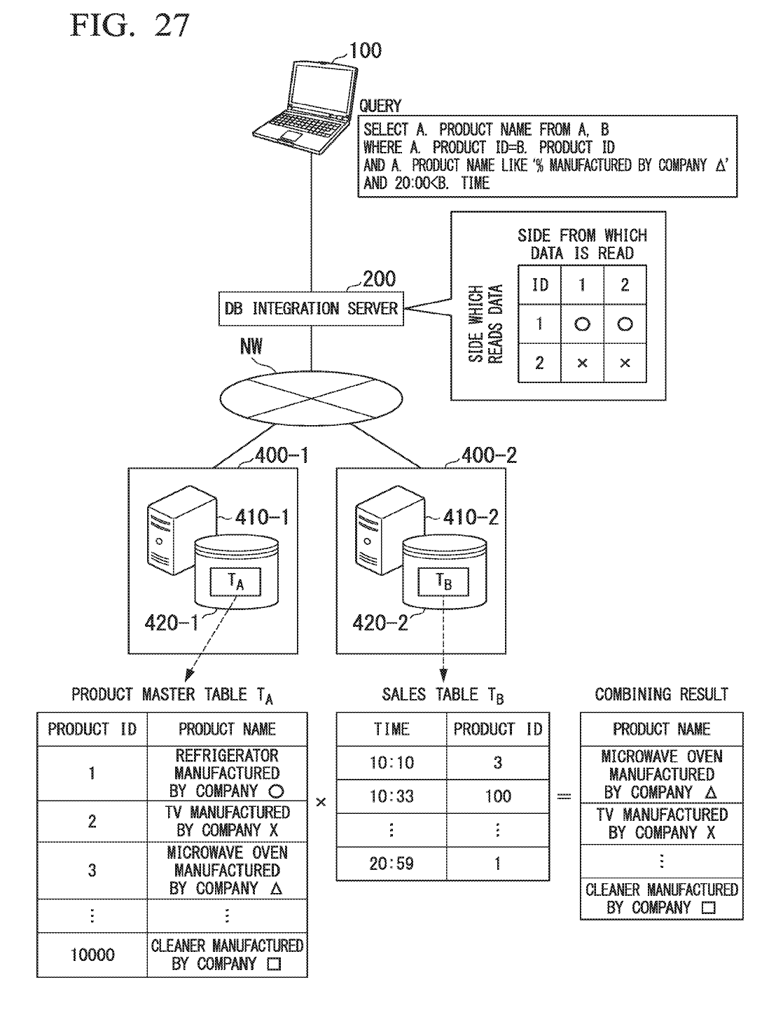

Example 3 will be described below. FIG. 27 is a diagram illustrating a state in which the DB integration server 200 receives a query from the user terminal 100 in Example 3. If the user wishes to know the name of a product manufactured by Company Δ sold after 20:00 on a given day, the DB integration server 200 is assumed to receive a query including the following SELECT statement from the user terminal 100.

SELECT A. PRODUCT NAME FROM A, B WHERE A. PRODUCT ID=B. PRODUCT ID AND A. PRODUCT NAME LIKE ‘% MANUFACTURED BY COMPANY Δ’ AND 20: 00<B. TIME

By interpreting the query, the DB integration server 200 generates an execution plan for searching for a product name (or product names) satisfying a condition that the product ID be the same, a product be manufactured by company Δ, and a clock time be after 20:00 in the tables T_{A} and T_{B}. Also, the DB integration server 200 determines that the DB system 400-1 can read data from the DB system 400-2, but the DB system 400-2 cannot read data from the DB system 400-1, with reference to the cooperative map 242. As a result, the DB integration server 200 designates the DB system 400-1 as the DB system 400 that is the pushdown destination.

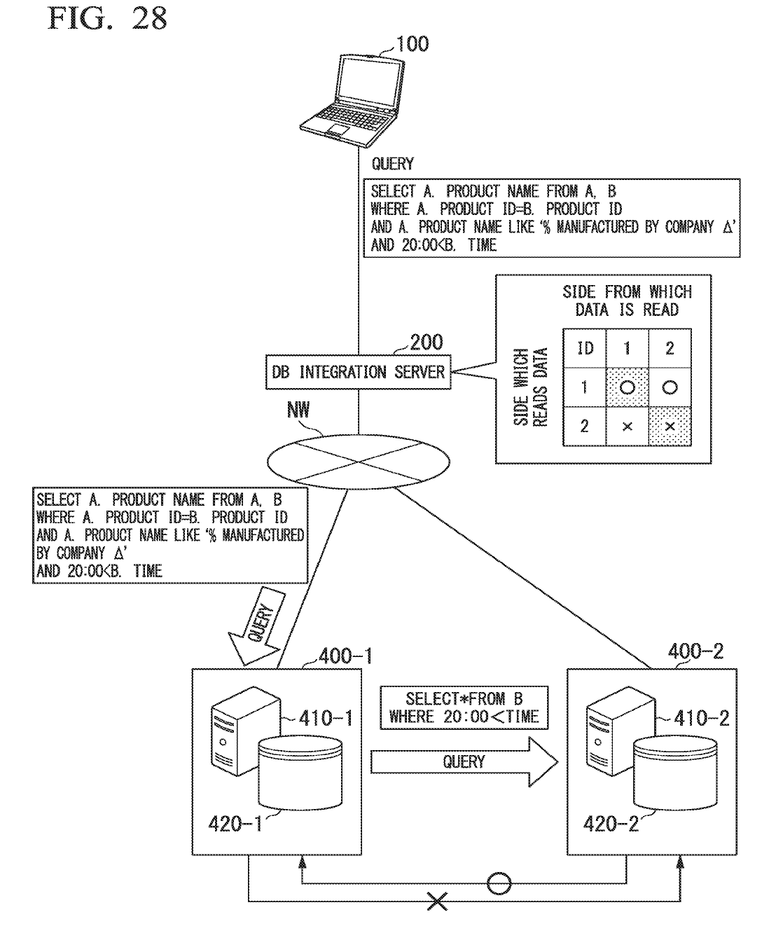

FIG. 28 is a diagram illustrating a state of transmitting an extraction condition from the DB system 400-1 to the DB system 400-2. The DB integration server 200 creates an execution plan for transmitting the extraction condition from the DB system 400-1 to the DB system 400-2. Thereby, the DB system 400-1 extracts data after a clock time of 20:00 from among data stored in the sales table T_{B} in the DB system 400-2 by sending an inquiry including the query “SELECT*FROM B WHERE 20:00<TIME” to the DB system 400-2. Thereby, as a result of combining the product master table T_{A} with the read sales table T_{B}, the DB system 400-1 transmits the name of a product manufactured by Company Δ sold at a time after 20:00 to the DB integration server 200.

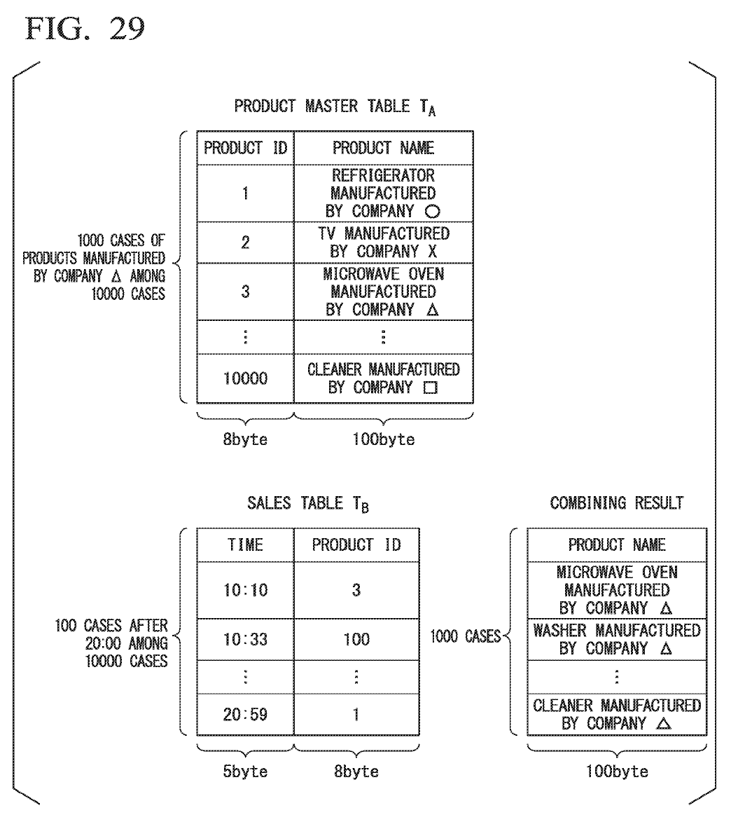

FIG. 29 is a diagram illustrating data sizes of a product master table T_{A}, a sales table T_{B}, and a combining result in Example 3. In Example 3, a data size of data (T_{A}#) related to a product manufactured by Company Δ in the product master table T_{A} is 108 KB, a data size of data (T_{B}#) after 20:00 in the sales table T_{B} is 1300 B, and a data size of the combining result is 10 KB. In this case, an amount of transmission of data in Example 3 is 11.3 KB, which is the sum of the data size of the data (T_{B}#) and the data size of the combining result. On the other hand, the amount of transmission of data in the comparative example is 109.3 KB, which is the sum of the data size of the data (T_{A}#) and the data size of the data (T_{B}#). As described above, according to Example 3, it is possible to suppress the amount of transmission more than in the comparative example.

According to at least one embodiment described above, the DB integration device includes: the pushdown designator 222 configured to designate a DB system 400 for executing a combining process of combining data to be combined that is specified in the query from among the plurality of DB systems 400 on the basis of the cooperative map 242 indicating whether or not each DB system of a combination of DB systems 400 including the DBs 420 storing the data to be combined that is specified in the query is able to perform the combining process by reading the data to be combined from a DB system 400 that is a combination partner and whether or not each DB system of a combination of DB systems 400 is able to cause the DB system 400 that is the combination partner to read the data to be combined; the plan generator 220 configured to generate an execution plan for causing the designated DB system to execute the combining process; and the plan instructor 250 configured to transmit information based on the query to the designated DB system on the basis of the execution plan. It is possible to execute a combining process at a higher speed by suppressing an amount of communication of data since it is unnecessary to receive data to be combined from the DB system 400.

The above mentioned embodiments may be described as follows.
[1] A system device including:
   a software component; and
   a hardware processor configured to execute the software component to perform at least:
   receiving a request for combining first data and second data;
   designating a DB system, from among a plurality of DB systems, for executing a combining process of combining the first data and the second data on the basis of combining capability information, the plurality of DB systems comprising a first DB system and a second DB system, the first DB system comprising a first DB storing the first data, and the second DB system comprising a second DB storing the second data, the combining capability information indicating at least one of: whether or not the first DB system is capable of reading the second data from the second DB system and executing the combining process; and whether or not the first DB system is capable of causing the second DB system to read the first data;
   generating an execution plan for causing the designated DB system to execute the combining process; and
   giving, on the basis of the execution plan, instructions to the designated DB system.
[2] A system including
   circuitry configured to perform at least:
   receiving a request for combining first data and second data;
   designating a DB system, from among a plurality of DB systems, for executing a combining process of combining the first data and the second data on the basis of combining capability information, the plurality of DB systems comprising a first DB system and a second DB system, the first DB system comprising a first DB storing the first data, and the second DB system comprising a second DB storing the second data, the combining capability information indicating at least one of: whether or not the first DB system is capable of reading the second data from the second DB system and executing the combining process; and whether or not the first DB system is capable of causing the second DB system to read the first data;
   generating an execution plan for causing the designated DB system to execute the combining process; and
   giving, on the basis of the execution plan, instructions to the designated DB system.
[3] A system including
   a software component;
   a hardware processor configured to execute the software component; and
   circuitry,
   the combination of the circuitry and the software component when executed by the hardware processor being configured to perform at least:
   receiving a request for combining first data and second data;
   designating a DB system, from among a plurality of DB systems, for executing a combining process of combining the first data and the second data on the basis of combining capability information, the plurality of DB systems comprising a first DB system and a second DB system, the first DB system comprising a first DB storing the first data, and the second DB system comprising a second DB storing the second data, the combining capability information indicating at least one of: whether or not the first DB system is capable of reading the second data from the second DB system and executing the combining process; and whether or not the first DB system is capable of causing the second DB system to read the first data;
   generating an execution plan for causing the DB designated system to execute the combining process; and
   giving, on the basis of the execution plan, instructions to the designated DB system.

While several embodiments of the present invention have been described, these embodiments have been presented by way of example only, and are not intended to limit the scope of the invention. These embodiments may be embodied in a variety of other forms. Various omissions, substitutions and changes may be made without departing from the spirit of the invention. The invention described in the accompanying claims and its equivalents are intended to cover such embodiments or modifications as would fall within the scope and spirit of the invention.

What is claimed is:

1. A database (DB) integration device comprising:
a receiver configured to receive at least a request for combining first data and second data;
a communicator configured to communicate with a plurality of DB systems, the plurality of DB systems comprising a first DB system and a second DB system, the first DB system comprising a first DB storing the first data, and the second DB system comprising a second DB storing the second data;
a designator configured to designate, from among at least one of the plurality of DB systems, a DB system for executing a combining process of combining the first data and the second data on the basis of combining capability information, the combining capability information indicating at least one of: whether or not the first DB system is capable of reading the second data from the second DB system and executing the combining process; and whether or not the first DB system is capable of causing the second DB system to read the first data;
a generator configured to generate an execution plan for causing the DB system designated by the designator to execute the combining process; and
an instructor configured to give, on the basis of the execution plan generated by the generator, instructions to the DB system designated by the designator through the communicator.

2. The DB integration device according to claim 1, wherein
the combining capability information indicates at least both of whether or not the first DB system is capable of reading the second data from the second DB system and executing the combining process and whether or not the first DB system is capable of causing the second DB system to read the first data.

3. The DB integration device according to claim 2, wherein
the combining capability information further indicates at least one of: whether or not the second DB system is capable of reading the first data from the first DB system and executing the combining process; and whether or not the second DB system is capable of causing the first DB system to read the second data.

4. The DB integration device according to claim 3, wherein
the combining capability information indicates at least both of whether or not the second DB system is capable of reading the first data from the first DB system and executing the combining process and whether or not the second DB system is capable of causing the first DB system to read the second data.

5. The DB integration device according to claim 1, wherein
the generator generates the execution plan for causing the DB system designated by the designator to send, to the second DB system, an extraction condition for extracting the second data.

6. The DB integration device according to claim 1, wherein,
in a case where each of two or more DB systems of the plurality of DB systems is capable of executing the combining process, the designator designates the DB system for executing the combining process from among the two or more DB systems on the basis of at least one of: a processing load to the two or more DB systems; and a total amount of data to be transmitted by the two or more DB systems.

7. The DB integration device according to claim 1, wherein
in a case where the first DB system is not capable of reading the second data from the second DB system, the second DB system is not capable of reading the first data from the first DB system, and the plurality of DB systems comprises a third DB system that is capable of reading the first data and the second data from the first DB system and the second DB system, the designator designates the third DB system as the DB system for executing the combining process, and
the generator generates an executing plan for transmitting the first data and the second data from the first DB system and the second DB system to the third DB system.

8. The DB integration device according to claim 1, wherein
in case where the first DB system is not capable of reading the second data from the second DB system, and the plurality of DB systems comprises a third DB system that is capable of relaying the second data from the second DB system to the first DB system, the designator designates the first DB system as the DB system for executing the combining process, and
the generator generates an execution plan for transmitting the second data from the second DB system through the third DB system to the first DB system.

9. The DB integration device according to claim 1, wherein
in a case where the first data and the second data are to be combined and another date is to be combined to the combined first and second data, the designator designates the DB system for executing the combining process on the basis of at least one of a processing load for the executing the combining process; and a total amount of data to be transmitted in the executing the combining process.

10. The DB integration device according to claim 1, wherein
the generator generates an execution plan for updating the combining capability information in a case where the receiver has received a request for adding a DB system or deleting one DB system of the plurality of DB systems, or a request for at least one of giving and taking at least an access right from one of the plurality of DB systems to another one of the plurality of DB systems.

11. A DB integration method comprising:
receiving a request for combining first data and second data;
designating a DB system, from among a plurality of DB systems, for executing a combining process of combining the first data and the second data on the basis of combining capability information, the plurality of DB systems comprising a first DB system and a second DB system, the first DB system comprising a first DB storing the first data, and the second DB system comprising a second DB storing the second data, the combining capability information indicating at least one of: whether or not the first DB system is capable of reading the second data from the second DB system and executing the combining process; and whether or not the first DB system is capable of causing the second DB system to read the first data;
generating an execution plan for causing the designated DB system to execute the combining process; and
giving, on the basis of the execution plan, instructions to the designated DB system.

12. A computer program product comprising a software program embodied on a non-transitory computer-readable storage medium, the software program being to be executed by a computer to perform a method, the method comprising:
receiving a request for combining first data and second data;
designating a DB system, from among a plurality of DB systems, for executing a combining process of combining the first data and the second data on the basis of combining capability information, the plurality of DB systems comprising a first DB system and a second DB system, the first DB system comprising a first DB storing the first data, and the second DB system comprising a second DB storing the second data, the combining capability information indicating at least one of: whether or not the first DB system is capable of reading the second data from the second DB system and executing the combining process; and whether or not the first DB system is capable of causing the second DB system to read the first data;
generating an execution plan for causing the designated DB system to execute the combining process; and
giving, on the basis of the execution plan, instructions to the designated DB system.
